(19) United States
(12) Patent Application Publication
(10) Pub. No.: US 2025/0297162 A1
(43) Pub. Date: Sep. 25, 2025

(54) AUGER-BASED PROCESSES AND APPARATUSES WITH CENTRALIZED HEATING FOR THERMAL TREATMENT OF CARBONACEOUS FEEDS

(71) Applicant: GTI Energy, Des Plaines, IL (US)

(72) Inventors: Zaher El Zahab, Orlando, FL (US); Martin B. Linck, Wilmette, IL (US)

(21) Appl. No.: 19/082,830

(22) Filed: Mar. 18, 2025

Related U.S. Application Data
(60) Provisional application No. 63/567,080, filed on Mar. 19, 2024.

(51) Int. Cl. C10B 47/44; C01B 3/36; C10B 53/00; C10B 57/14; C10J 1/26

(52) U.S. Cl. CPC C10B 47/44; C01B 3/36; C10B 53/00; C10B 57/14; C10J 1/26; C01B 2203/0255

(57) ABSTRACT

Aspects of the invention are associated with the discovery of approaches for the conversion of carbonaceous feeds, such as biomass and biomass-containing solids via thermal treatment. Particular examples of biomass-containing solids are municipal solid waste (MSW), as well as waste plastics and waste tires. In some cases, this conversion, such as by pyrolysis, will allow for straightforward integration with gasification (e.g., entrained-flow gasification) or partial oxidation. Advantageously, processes and associated apparatuses/equipment described herein are tailored to the physical and chemical properties of the feeds. In this regard, important advantages reside in auger reactors that include electric heating elements within one or more auger shafts. Such centralized heating may be used in combination with external heating, for example also utilizing electric heaters. With centralized heating, the surface area available for heat transfer into the feedstock may be increased dramatically (e.g., by a factor of 3 to 5).

### CROSS REFERENCE TO RELATED APPLICATION

This application claims the benefit of priority to U.S. Provisional Application No. 63/567,080, filed Mar. 19, 2024, which is hereby incorporated by reference in its entirety.

### FIELD OF THE INVENTION

Aspects of the invention relate to processes and apparatuses for the thermal treatment of biomass or other carbonaceous feeds, including pyrolytic and/or oxidative thermal treatment, utilizing an auger reactor comprising an auger conveyor with centralized heating.

### DESCRIPTION OF RELATED ART

Auger reactors, which use a screw to convey a solid feedstock down the length of a tube, are gaining attention not only for fast pyrolysis, but also for slow or intermediate pyrolysis. Augers were originally designed simply to convey, not to mix. They have been used in a number of industrial applications, especially for feeding/extraction processes. These devices have been widely used for elevating, transporting, and/or mixing solid particles at controlled and steady rates in different industries including mining, agriculture, construction, chemicals, and food, and more recently in energy systems. They also have prospects for small scale, distributed processing of different kinds of feeds.

Pyrolysis is an endothermic process performed in an oxygen-free atmosphere at typically from 250° C. to 600° C., depending on the characteristics of the particular feed and objectives to be achieved, such as whether the solid, liquid or the gaseous fraction should be maximized. Heat transport into the reactor is needed to drive the thermal decomposition of the feed into products. For example, US 2011/0067991 discloses, as a possible solution for achieving this heat input in an auger-based system, mixing a solid heat carrier with biomass feed, together with mechanical agitation. Work with single-auger systems for devolatilization of biomass is disclosed in publications such as Funke et al., (“Modelling and improvement of heat transfer coefficient in auger type reactors for fast pyrolysis application,” CHEMICAL ENGINEERING & PROCESSING: PROCESS INTENSIFICATION, 2018). A review of biomass pyrolysis is found in Campuzano et al., (“Auger reactors for pyrolysis of biomass and wastes,” RENEWABLE AND SUSTAINABLE ENERGY REVIEWS, 2019). In a later publication by Campuzano et al., (“Pyrolysis of Waste Tires in a Twin-Auger Reactor Using CaO: Assessing the Physicochemical Properties of the Derived Products,” ENERGY FUELS, 2021) the conversion of waste tires in a twin-auger pyrolysis system is reported. In the course of DOE-funded research, Felix et al. (US DOE Final Report DE-FE0005349, 2015) describe the operation of a commercial twin-screw extruder system at very high pressure, which subjected biomass to the effect of super-critical water.

Whereas auger-based reactors have been proposed for these and other uses, practical limitations of known systems have hindered their economical attractiveness, as needed for commercial implementation. Ongoing development of these reactors for not only pyrolysis, but also other thermal treatment processes such as torrefaction, gasification, and partial oxidation, is therefore necessary. In some cases, pyrolysis or torrefaction is desired as an initial, first step that precedes an oxidative conversion, such as gasification, partial oxidation, or possibly the combustion, of the resulting pyrolysis vapors or torrefaction vapors.

### SUMMARY OF THE INVENTION

Aspects of the invention are associated with the discovery of approaches for the conversion of carbonaceous feeds via thermal treatment, as described herein. These carbonaceous feeds include biomass and biomass-containing solids (e.g., biomass-containing mixtures, such as municipal solid waste (MSW)), as well as polymers (e.g., plastics, such as waste plastics, and rubbers, such as waste tires). In the case of biomass-containing solids, and particularly biomass-containing mixtures, some components of these mixtures may be non-carbonaceous solids, such as glass and/or metals. In some cases, the conversion, such as by pyrolysis or torrefaction, will allow for straightforward integration with gasification, such as entrained-flow gasification, or otherwise with partial oxidation. Advantageously, processes and associated apparatuses/equipment described herein may be tailored to the physical and chemical properties of the carbonaceous feeds.

Exemplary processes may employ, for at least part of the thermal treatment, an initial devolatilization (e.g., pyrolysis, torrefaction, gasification, or partial oxidation) stage that is adapted to characteristics that are particularly relevant to biomass and MSW, as well as the opportunities (for upgrading/monetization) and challenges (heterogeneity/lack of conveyability) associated with these carbonaceous feeds. In one embodiment, an auger reactor may be particularly effective for performing the thermal treatment, in terms of its capability to devolatilize incoming carbonaceous feed, for example in the form of biomass or biomass-containing solids having been shredded. Devolatilization of (removal of volatile components from), the carbonaceous feed in the auger reactor may occur over the course of a total solids residence time of less than about 5 minutes. The thermal treatment, all or a portion of which may include pyrolysis, torrefaction, gasification, or partial oxidation, results in the conversion of at least a portion the carbonaceous feed into a gaseous product, such as, (i) in the case of pyrolysis or torrefaction, a hot, gaseous, high-pressure stream of volatile components (pyrolysis vapors or torrefaction vapors), or (ii) in the case of gasification or partial oxidation, a syngas product. In utilizing a downstream gas-solid separation, a resulting solids-depleted gaseous product, which may be free or substantially free of solid particles (e.g., those entrained in the gaseous product exiting the auger reactor), can be separated. Preferably following solids removal, the gaseous product (e.g., solids-depleted pyrolysis vapors, solids-depleted torrefaction vapors, or solids-depleted syngas product), as a particular thermal treatment conversion product, may be suitable for being directly routed or fed into a partial oxidation (POX) stage. More generally, such gaseous product may be introduced or fed to a secondary thermal treatment vessel (e.g., reactor) to provide a purified syngas product, having an increased syngas content (combined amount of H₂ and CO). The secondary thermal treatment vessel may generally operate at higher temperatures, such as above about 800° C. (e.g., from about 800° C. to about 1750° C.), or above about 850° C. (e.g., from about 850° C. to about 1600° C.), relative to the initial pyrolysis, torrefaction, or gasification.

The initial devolatilization may also produce, as another product of the thermal treatment, a char product (e.g., biochar, torrefied biomass, or bio-coal), containing, for example, substantially all of the fixed carbon and ash (non-combustibles) content of the carbonaceous feed. Importantly, a reactor for performing this devolatilization (devolatilizer, such as a pyrolysis reactor or torrefaction reactor, or a gasification reactor) should have the capability, and therefore the flexibility, for effectively converting biomass, biomass-containing solids (e.g., MSW), or combinations of these in any ratio, under elevated operating pressures, such as of up to 30 bar or more, as well as the further capability for supplying the energy for heating the carbonaceous feed, such as up to 600° C. or more. These features can allow for direct integration of an initial devolatilization stage with a subsequent, secondary thermal treatment stage (e.g., a subsequent POX stage), as another portion of the thermal treatment, and further with pressurized synthesis equipment downstream of the POX stage.

In some particular embodiments, devolatilization may benefit from particular operating principles of auger conveyors including at least one auger, and in many cases two augers, such as an auger conveyor in the form of a twin-screw extruder. Single auger, dual auger, and multi-auger conveyers, with the particular number of augers being dictated at least in part by the carbonaceous feedstock throughput requirements, represent suitably powerful, robust, and exceptionally capable apparatuses in terms of promoting the conversion, via thermal treatment, of a wide range of carbonaceous feeds that are conventionally recognized as being difficult to process. These include polymers from plastics manufacturing and waste tires, as well as glass formers from float glass manufacturing facilities. Additionally, the use of electricity, which may be renewably sourced, for powering the devolatilizer (e.g., auger reactor for performing the thermal treatment including pyrolysis, torrefaction, gasification, or partial oxidation), may reduce capital and operating costs/complexities. For example, renewable power may be used to carry out the initial devolatilization, to attain the desired conversion, of challenging feedstocks, on a carbon-neutral or even carbon-negative basis. In some embodiments for performing the devolatilization (e.g., pyrolysis, torrefaction, gasification, or partial oxidation) of biomass and biomass-containing solids (e.g., MSW), an electrically-heated single-auger or twin-auger reactor may be particularly suitable.

Particular aspects of the invention are associated with the discovery that heat transfer coefficients associated with the interaction of solids within the annular spaces of augers can be comparable to those favorably attained with the use of fluidized bed reactors. That is, the rate of heat transfer may approach the highest values achievable in the context of particle-particle interaction, while avoiding disadvantageous operational requirements and constraints of a fluidized bed reactor. For this reason, auger-based thermal treatment, including devolatilization (e.g., pyrolysis, torrefaction, gasification, or partial oxidation) processes and systems utilizing an auger reactor as described herein, can involve certain operating principles leading to results that are superior to conventional alternatives. Heated auger reactors can convey even seemingly problematic feedstocks into the space (e.g., annular space or other appropriately-formed space) surrounding the central screw/screws (or shaft(s) of these screw(s)) with its/their flights. Other design features of these reactors promote the efficient delivery of torque and overall axial movement requirements as needed to force even viscous or molten masses (e.g., melted plastics or materials with similarly challenging properties, such as heated tire waste) through the thermal treatment (e.g., devolatilization, such as pyrolysis or torrefaction, or otherwise gasification or partial oxidation) as needed to attain the desired conversion over the axial length of the auger.

A twin-auger reactor, in which the auger conveyor of the auger reactor includes two augers, may be particularly advantageous, with respect to the interaction of the flights of two adjacent screws (or central screws) of the two augers. This interaction can beneficially hinder or prevent adherence of softened polymers, or materials similarly prone to developing tack or stickiness, to either of the two augers, under a broad range of thermal treatment conditions. A dual-auger configuration can maintain forward movement of a plug of solid carbonaceous feed, undergoing devolatilization, in an uninterrupted manner along its movement path. This path is in the direction of the central shaft(s) of the auger(s), extending from an upstream axial position to a downstream axial position, and is typically horizontal, although other axial alignments of the auger(s) and associated movement paths, such as upwardly-inclined or downwardly-inclined, may also be utilized. Particular aspects of the invention relate to the finding that a twin-auger reactor has exceptional capabilities, in terms of accepting, conveying, and converting types of carbonaceous feeds (e.g., biomass and MSW) that are of particular importance in the realm of pressurized gasification and conversion to synthesis gas (i.e., a gaseous product comprising H₂ and CO). To facilitate the use of an auger reactor, the carbonaceous feed such as biomass may be initially sized, for example by being first shredded to a given target size, according to a largest dimension (e.g., a nominal screen size) that may be, in various embodiments, about 1 cm, about 5 cm, or about 10 cm, in order to improve handling characteristics. Non-biomass materials that might hinder or even damage operation of the auger(s), such as metals (e.g., lengths of wire or chain), metal oxides (including rocks and minerals), and glass, are preferably removed prior to loading into the auger reactor.

Important aspects relate to the discovery that auger reactors for thermal treatment (e.g., devolatilization, such as pyrolysis or torrefaction, or otherwise gasification or partial oxidation), which rely solely on external heating, for example with electric heaters, may be vulnerable to operational difficulties when converting feeds that contain polymers, and particularly those that soften at low temperatures. Auger reactors for thermal treatment (e.g., pyrolysis, torrefaction, gasification, or partial oxidation), such as those in which the auger conveyor includes two augers (i.e., in the case of a twin-auger reactor), while being capable of processing even challenging feedstocks, possess certain complexities that are not necessarily compatible with external heating alone. For example, the rate of heat transfer to the carbonaceous feed may be limited to that which can be achieved across an inner sleeve, which is not configured to isolate the operating pressure, and/or across an outer pressure shell, enclosing the auger assembly and configured to maintain above-atmospheric pressure (e.g., by sealing an annular space surrounding central auger screw(s)) as a desired thermal treatment condition. The use of elevated pressure (e.g., up to 30 bar or more) for an auger-based thermal treatment (e.g., pyrolysis or torrefaction) is particularly relevant for integration with a downstream POX reactor, as another (non auger-based) part of this thermal treatment, to produce particle-free, tar-free syngas from this combination of steps. More generally, a secondary, non auger-based thermal treatment may be integrated with the auger-based thermal treatment, by introducing a gaseous product of the auger-based thermal treatment, optionally following solids removal (e.g., pyrolysis vapors or solids-depleted pyrolysis vapors, torrefaction vapors or solids-depleted torrefaction vapors, a syngas product or solids-depleted syngas product), to partial oxidation (POX) stage or, more generally, a secondary thermal treatment vessel (e.g., reactor), in any event providing a purified syngas product as described herein. The secondary thermal treatment vessel may operate, for example, at a temperature above about 850° C., as necessary to carry out desired reactions such as methane cracking, thereby improving the quality of the purified syngas.

Although desirable from the standpoint of reaction efficiency and avoiding compression between thermal treatment steps, pressurized operation of the auger-based thermal treatment can lead to practical difficulties if all process heat is to be transmitted externally with respect to the auger. External heat transmission may be directed inwardly from peripheral heaters, for example across an inner sleeve and/or an outer pressure shell of the auger assembly (e.g., with the latter sealing the environment in which the thermal treatment conditions, including operating pressure and operating temperature, are maintained, from the external environment). Sufficient heat input in this manner can require excessive temperatures of the inner sleeve, outer pressure shell, and/or other components of a pressurized auger reactor, necessitating enhanced pressure-temperature characteristics of the reactor equipment/structures.

Importantly, however, certain advantages of the invention are associated with the recognition that the auger itself with its central shaft and flights, rather than the radially-farther disposed inner sleeve and outer pressure shell, provides a more directly accessible surface area for heat transfer to the carbonaceous feed. In this regard, embodiments of the invention are directed to important advantages that reside in the use of auger reactors for the conversion of carbonaceous feed, via thermal treatment such as pyrolysis, torrefaction, gasification, or partial oxidation, with such reactors including electric heating elements within one or more auger shafts of the respective, one or more augers. Centralized heating may be used in combination with external heating (e.g., radially outside of the carbonaceous feed conversion zone, but not necessarily outside of the auger reactor), for example also utilizing electric heaters. In the case of supplemental external heating, duty requirements of one or more peripheral heaters may be beneficially reduced as a result of accompanying, centralized heat input. Peripheral heaters are those disposed externally to the central shaft(s) and flights of the one or more augers, such as surrounding an inner sleeve that may also be referred to as an auger sleeve (e.g., the tubular shell enclosing the augers), and/or those surrounding a more radially-farther disposed outer pressure shell. Centralized heating can increase the operability of both internal (central) and external (peripheral) heaters and their heating elements, for example by reducing the temperature required of the inner sleeve, outer pressure shell, and/or other components external to the shafts and flights of the auger(s), as needed to establish sufficient heat input. Whether or not external heating is utilized, centralized heating can dramatically increase (e.g., by a factor of 3 to 5) the surface area available for heat transfer into the carbonaceous feed, compared to the use of external heating with peripheral heaters alone. Overall improvements of centralized heating from within auger shaft(s), optionally in combination with external heating, namely from outside, or from the exterior of, the outer radius or radii of the auger(s) (e.g., in the case of heating elements surrounding the inner sleeve and/or outer pressure shell) may further include longer operational intervals and increased flexibility, in terms of available options for heat input.

Further aspects of the invention relate to the recognition that the operation of auger reactors with external heat input alone results in limitations in heat transfer, caused by constraints in the surface area of the auger sleeve enclosing the auger assembly, as well as other components external to the auger shaft and flights. To address these limitations, certain embodiments of the invention are directed to auger reactors, as well as thermal treatment processes (e.g., pyrolysis, torrefaction, gasification, and POX) utilizing such reactors, that incorporate centralized, electric heating elements, such as bayonet heating elements, within a hollow volume of one or more (e.g., two) auger shafts. This centralized heating may be supplemented with external heating, and one or both of these types of heating may utilize electric heating elements. In addition to significantly increasing the surface area available for heat transfer into the carbonaceous feed, centralized heating can address a number of problems, for example as noted above, which result from external heating alone. This can beneficially reduce the severity of peripheral heater operation and accompanying inner sleeve/outer shell temperatures, prevent other adverse thermal gradients through the auger hardware, and lengthen equipment lifetimes. Importantly, significant temperature gradients can mechanically limit the maximum operating pressure of an auger reactor and thereby preclude the use of pressures matching those of typical POX reactors or, more generally, vessels used to perform secondary thermal treatment. These matching pressures are an important consideration in avoiding costly, intermediate compression downstream of the auger based reactor and upstream of a secondary thermal treatment (e.g., to provide a purified syngas product).

Centralized heating can advantageously ameliorate or overcome limitations as described above, for example by allowing for more balanced heat input, directed (i) outwardly (according to centralized heating) from within the auger shaft(s), as well as (ii) inwardly (according to external heating) from (a) an inner sleeve that is within an operating pressure used in the conversion zone about the auger shaft(s) and/or (b) an outer pressure shell that contains this operating pressure. Particularly in the case of (ii)(a), the use of one or more heating elements that are exposed to the operating pressure, for example by being disposed on, by surrounding, and/or by being near to, the inner sleeve but nonetheless interior to the outer pressure shell, results in components of the auger reactor not requiring simultaneous high pressure/high temperature service and the associated, stringent structural requirements. In this regard, an inner sleeve may be required to withstand high temperatures (e.g., may be heated to an operating temperature within a range as described herein), but have substantially equal pressures on both of its interior and exterior surfaces (i.e., may be pressurized to an operating pressure within a range as described herein, but maintain little or no pressure gradient, such as a pressure gradient of less than about 1 bar, or less than about 0.5 bar). An outer pressure shell, in contrast, may be required to withstand high pressure gradients (e.g., have an exterior surface exposed to ambient pressure and an interior surface exposed to an operating pressure within a range as described herein), but have ambient or relatively low temperatures, such as temperatures of less than about 100° C. or less than about 50° C., on both of its interior and exterior surfaces.

In this manner, an inner sleeve and an outer pressure shell may be advantageously configured to divide their “responsibilities” in terms of maintaining, respectively, high temperature gradients and high pressure gradients, thereby significantly reducing overall stresses in the auger reactor. Having knowledge of the present disclosure, those skilled in the art will appreciate how centralized heating, in general and also in particular embodiments disclosed herein, can mitigate thermal gradients through the auger hardware and overall auger reactor as a whole. Among other advantages, this facilitates high-pressure operation of auger reactors, as needed for effective, direct transfer, such as through an insulated conduit, of the gaseous product (e.g., hot volatile components, such as pyrolysis vapors, torrefaction vapors, or gasification vapors), resulting from devolatilization of the carbonaceous feed, to a POX reactor inlet, or inlet of a vessel more generally used to perform a secondary thermal treatment.

These and other embodiments, aspects, and advantages relating to the present invention are apparent from the following Detailed Description.

### BRIEF DESCRIPTION OF THE DRAWINGS

A more complete understanding of the exemplary embodiments of the present invention and the advantages thereof may be acquired by referring to the following description in consideration of the accompanying figures, in which the same reference numbers are used to indicate the same or similar features.

FIGS. 1A and 1B illustrate, respectively, a side view and a top view of a twin-auger system, namely an auger reactor having an auger conveyor with two augers, and certain associated components.

FIGS. 2A and 2B illustrate the respective side and top views as shown in FIGS. 1A and 1B, but with additional details relating to the depiction of the auger flights and components in order from the interior to the exterior of the auger reactor.

FIG. 3 illustrates a cross-sectional view of a twin-auger system, for example according to the embodiments illustrated in FIGS. 1A, 1B, 2A, and 2B.

FIG. 4 illustrates a simplified flow diagram, according to which an auger reactor (e.g., a twin-auger system) is implemented for thermal treatment (e.g., pyrolysis, torrefaction, gasification, or partial oxidation) of biomass, such as present in MSW, in combination with gas/solid separation, to produce a solids-depleted gaseous product (e.g., solids-depleted pyrolysis vapors, solids-depleted torrefaction vapors, or solids-depleted syngas product) to produce pyrolysis vapors as a gaseous product, in addition to a char product.

FIG. 5 illustrates a particular embodiment, according to which an auger reactor (e.g., twin-auger system) is integrated in an overall process that includes downstream POX, followed by methanol synthesis.

Whereas the figures illustrate multiple possible features that may be implemented individually or in any combination, not all features are required in, or essential to, the various inventive embodiments as described herein and defined by the appended claims. It should be understood that various specific features can be used independently of others.

In order to facilitate explanation and understanding, the figures provide overviews of apparatuses and unit operations that may be implemented in thermal treatment processes for converting carbonaceous feeds via thermal treatment, such as for converting biomass to either pyrolysis vapors (via pyrolysis), torrefaction vapors (via torrefaction), or syngas (via gasification or partial oxidation). Some associated equipment such as certain vessels, heat exchangers, valves, instrumentation, and utilities, are not shown, as their specific description is not essential in the practice of various inventive embodiments. Such details would be apparent to those skilled in the art, having knowledge of the present disclosure. Other processes for producing pyrolysis vapors, torrefaction vapors, or syngas, according to other embodiments within the scope of the invention and having configurations and constituents determined, in part, according to particular processing objectives, would likewise be apparent.

### DETAILED DESCRIPTION

The expressions “wt-%” and “mol-%,” are used herein to designate weight percentages and molar percentages, respectively. The expressions “wt-ppm” and “mol-ppm” designate weight and molar parts per million, respectively. For ideal gases, “mol-%” and “mol-ppm” are equal to percentages by volume and parts per million by volume, respectively. The terms “barg” and “bar,” when used herein, designate gauge pressures (i.e., pressure in excess of atmospheric pressure) and absolute pressures, respectively, in units of bars. For example, a gauge pressure of 0 barg is equivalent to an absolute pressure of 1 bar.

The term “substantially,” as used herein, refers to an extent of at least 95%. For example, the phrase “substantially all” may be replaced by “at least 95%.” The phrases “all or a portion” or “at least a portion” are meant to encompass, in certain embodiments, “at least 50% of,” “at least 75% of,” “at least 90% of,” and, in preferred embodiments, “all.” Reference to any starting material, intermediate product, or final product, which are all preferably solid-, liquid-, and/or gas-containing process streams in the case of continuous processes, should be understood to mean “all or a portion” of such starting material, intermediate product, or final product, in view of the possibility that some portions may not be used, such as due to sampling, purging, diversion for other purposes, mechanical losses, etc. Therefore, for example, the phrase “contacting the solids-depleted syngas product with an oxygen-containing secondary reactor feed” should be understood to mean “contacting all or a portion of the solids-depleted syngas product with an oxygen-containing secondary reactor feed.” As in the case of “all or portion” being expressly stated, when “all or a portion” is the understood meaning, this phrase is should likewise be understood to encompasses certain and preferred embodiments as noted above.

Embodiments of the invention are directed to auger-based processes for the thermal treatment of a carbonaceous feed (e.g., biomass). Such thermal treatment may include pyrolysis or torrefaction, performed in the absence or substantial absence of oxygen (i.e., in the case of an auger-based pyrolysis process or auger-based torrefaction process). The terms “pyrolysis” and “torrefaction” are art-recognized thermal decomposition processes, occurring under thermal treatment conditions that include temperatures typically ranging, respectively, from about 450° C. to about 600° C., and from about 200° C. to about 350° C. In this regard, torrefaction may be considered a mild form of pyrolysis.

In the case of either pyrolysis or torrefaction, oxygen may be present in the auger reactor (e.g., conversion annulus of the auger reactor) in a concentration of less than about 5 mol-% or less than about 1 mol-%. If a gaseous auger reactor feed is utilized/introduced in an auger-based pyrolysis process or auger-based torrefaction process (e.g., through a vapor feed port of an auger-based pyrolysis reactor or an auger-based torrefaction reactor), such feed may have an oxygen concentration that is limited to these ranges and may therefore act essentially as an inert gas. For example, a gaseous auger reactor feed or gaseous torrefaction feed may comprise all or substantially all N₂, or all or substantially all CO₂, and act as a carrier gas to facilitate conveyance of the carbonaceous feed. The gaseous auger reactor feed may be considered, in the case of pyrolysis or torrefaction, an inert carrier gas-containing feed.

A representative thermal treatment may also include gasification or partial oxidation (POX), performed in the presence of limited oxygen, for example sufficient to supply generally 20%-70% of that needed for complete combustion. The oxygen may be introduced to the auger reactor in an oxygen-containing auger reactor feed, which, in addition to oxygen, may comprise other oxygenated gaseous components including H₂O and/or CO₂ that may likewise serve as oxidants of the carbonaceous feed (e.g., biomass) in the carbonaceous feed conversion zone. In the case of introducing an oxygen-containing auger reactor feed in an auger-based gasification process or an auger-based partial oxidation process (e.g., through a vapor feed port of an auger gasification reactor or auger partial oxidation reactor), such feed may have an oxygen concentration from about 1 mol-% to about 30 mol-%, such as from about 5 mol-% to about 25 mol-%. The oxygen-containing auger reactor feed may, for example, comprise air, oxygen-enriched air, and/or electrolysis oxygen.

According to some embodiments in which the thermal treatment in the auger reactor is pyrolysis or torrefaction, the resulting gaseous product (e.g., pyrolysis vapors or torrefaction vapors), optionally following a separation to remove entrained solid particles, may be subsequently subjected to gasification or partial oxidation. In the case of a separation, the resulting solids-depleted pyrolysis vapors or solids-depleted torrefaction vapors, may be contacted with an oxygen-containing secondary reactor feed, for example supplying limited oxygen and/or having other characteristics, as described above with respect to the oxygen-containing auger reactor feed. More generally, according to some embodiments in which the thermal treatment in the auger reactor is pyrolysis, torrefaction, or gasification, the resulting gaseous product (e.g., pyrolysis vapors, torrefaction vapors, or gasification vapors), optionally following a separation to remove entrained solid particles, may be subsequently subjected to a secondary thermal treatment. In the case of a separation, the resulting solids-depleted pyrolysis vapors, solids-depleted torrefaction vapors, or solids-depleted gasification vapors, may be introduced or fed to a secondary thermal treatment vessel (reactor), operating at a sufficiently high temperature, such as above about 800° C. (e.g., from about 800° C. to about 1750° C.), or above about 850° C. (e.g., from about 850° C. to about 1600° C.), to convert tars and/or other components (e.g., methane) of the solids-depleted gaseous product into additional syngas (H₂ and/or CO). In this manner, the product of the secondary thermal treatment (e.g., POX) may be considered a “purified syngas product,” insofar as the total concentration or amount of H₂ and/or CO is increased relative to the solids-depleted gaseous product (e.g., solids-depleted pyrolysis vapors, solids-depleted torrefaction vapors, or solids-depleted gasification vapors) directly upstream of the secondary thermal treatment. The purified syngas product may comprise predominantly H₂ and CO, for example the combined concentration of H₂ and CO may be at least about 50 mol-%, at least about 60 mol-%, or even at least about 75 mol-%.

A “carbonaceous feed” may comprise materials that are conventionally understood as being difficult to process/monetize utilizing pyrolysis, optionally in combination with other thermal treatment steps, such as oxidative thermal treatment steps that include gasification or partial oxidation. These materials include polymers, for example (i) waste plastics, such as polyethylene, polypropylene, poly(vinyl chloride) (PVC), polyesters, polyethylene terephthalate (PET) and/or polystyrene, as well as (ii) waste rubbers (e.g., waste tires). The carbonaceous feed may comprise coal (e.g., high quality anthracite or bituminous coal, or lesser quality subbituminous, lignite, or peat), heavy petroleum fractions (e.g., petroleum coke), asphaltene, and/or liquid petroleum residue, or other fossil-derived substances. The carbonaceous feed may comprise miscellaneous wastes including sewage sludge, de-inking sludge, aseptic packages, waste food, medium density fiberboard (MDF), waste tires and/or plastic wastes.

In some embodiments, the carbonaceous feed may comprise biomass. The term “biomass” refers to renewable (non-fossil-derived) substances derived from organisms living above the earth's surface or within the earth's oceans, rivers, and/or lakes. Representative biomass can include any plant material, or mixture of plant materials, such as a hardwood (e.g., whitewood), a softwood, a hardwood or softwood bark, lignin, algae, and/or lemna (sea weeds). Energy crops, or otherwise agricultural residues (e.g., logging residues) or other types of plant wastes or plant-derived wastes, may also be used as plant materials. Specific exemplary plant materials include corn fiber, corn stover, and sugar cane bagasse, in addition to “on-purpose” energy crops such as switchgrass, miscanthus, and algae. Short rotation forestry products, such as energy crops, include alder, ash, southern beech, birch, eucalyptus, poplar, willow, paper mulberry, Australian Blackwood, sycamore, and varieties of paulownia elongate. Other examples of suitable biomass include organic waste materials, such as waste paper, construction, demolition wastes, digester sludge, and biosludge. For example, the biomass may be present in municipal solid waste (MSW) or may be a product derived from MSW, such as refuse derived fuel (RDF). The biomass may therefore, in general, be present as a combination of fossil-derived and renewable substances. The fossil-derived substances may include plastics, which may be present in the carbonaceous feed, in individual or combined amounts from about 10 wt-% to about 85 wt-%, from about 20 wt-% to about 80 wt-%, or from about 35 wt-% to about 75 wt-%. For example, MSW may include, as plastics, any one or more of polyethylene, polypropylene, poly(vinyl chloride) (PVC), polyesters, polyethylene terephthalate (PET) and/or polystyrene, individually in these amounts within these ranges, or in combined amounts within these ranges. The fossil-derived substances may include, alternatively or optionally in combination with plastics, waste rubbers in amounts within these ranges.

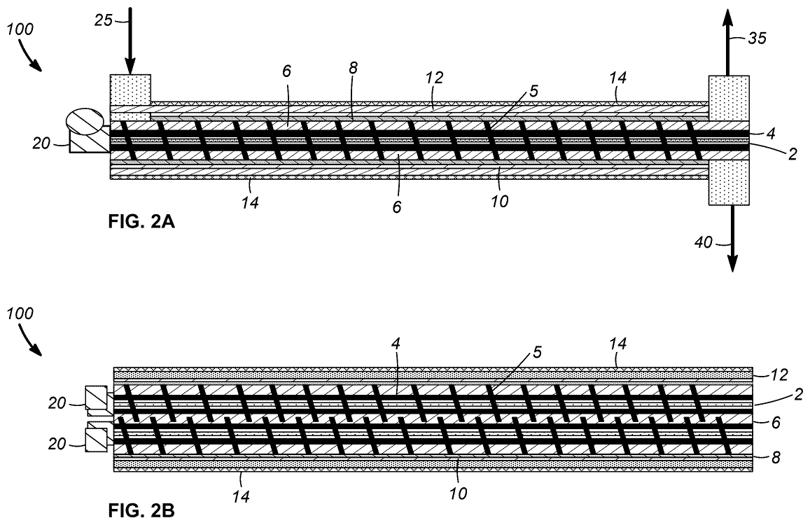

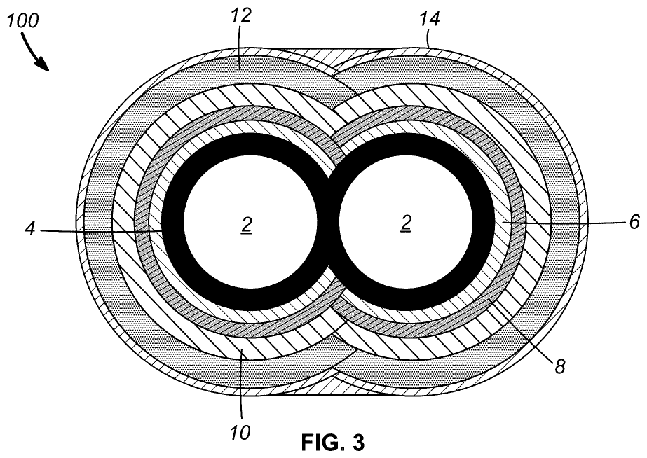

In the context of auger reactors and their components, the terms “external,” “internal,” “exterior,” “interior,” “outer,” and “inner” are in reference to relative radial positions about the shaft or shafts of auger(s), with internal, interior, or inner components being radially nearer to the shaft(s) and external, exterior, or outer components being, or extending, radially farther from the shaft(s). In the same manner, an “interior” surface of a given component (e.g., inner sleeve or outer pressure shell) should be understood as that surface that is radially nearer to, or facing toward, the shaft(s) of auger(s), whereas an “exterior” surface is radially farther from, or facing away from, the shaft(s) of auger(s). For example, with reference to the specific configurations shown in FIGS. 2A, 2B, and 3, components of an auger reactor, from its interior to its exterior, may include (i) central heating element 2 (e.g., electric bayonet heater), (ii) central shaft 4 of the auger (e.g., constructed of heavy-wall pipe), within which the central heating element is housed, and from which flights 5 are mounted, (iii) the carbonaceous feed (e.g., biomass) conversion zone 6 (such as, more particularly, a conversion annulus), into which the flights 5 extend, (iv) an inner sleeve 8 (e.g., auger sleeve), (v) peripheral heater(s) 10 (e.g., external electric heating elements), (vi) an insulation layer 12, and (vii) a pressure shell 14.

Representative auger-based processes described herein refer to positions (e.g., axial positions), steps, unit operations, or apparatuses, with one position, step, unit operation, or apparatus being “upstream,” or “prior,” relative to another position, step, unit operation, or apparatus, or with one position, step, unit operation, or apparatus being “downstream,” or “subsequent” relative to another position, step, unit operation, or apparatus. These quoted terms, which refer to the order in which one position, step, unit operation, or apparatus is relative to another, are in reference to the overall process flow, as would be appreciated by one skilled in the art having knowledge of the present specification. More specifically, the overall process flow can be defined by the bulk carbonaceous feed flow through the auger reactor and bulk gaseous product (e.g., pyrolysis vapors or syngas product) flow through any additional reaction steps (if used), such as gasification or partial oxidation, and methanol synthesis. Insofar as the above-quoted terms are used to designate order, in specific embodiments these terms mean that one position, step, unit operation, or apparatus immediately precedes or follows another, whereas more generally these terms do not preclude the possibility of one or more intervening positions, steps, unit operations, or apparatuses.

The terms “pyrolysis vapors,” and “torrefaction vapors,” as particular gaseous products that are obtained from the auger reactor being operated, respectively, for pyrolysis and torrefaction as particular thermal treatments of the carbonaceous feed (e.g., biomass), as well as in the terms “solids-depleted pyrolysis vapors,” and “solids-depleted torrefaction vapors” refer to the gaseous volatile components that are separated from, by devolatilization of, this feed upon heating or exposure to the thermal treatment conditions within the auger reactor (e.g., within the carbonaceous feed conversion zone, such as the conversion annulus of the auger reactor). These gaseous volatile components may include, for example, water and C₁-C₈ hydrocarbons, optionally having a carbon-carbon (—CH₂—CH₂—) bond replaced with a carbon-oxygen (—CH₂—O—) bond and/or optionally having a terminal hydrogen radical (—H) substituted with a terminal carbonyl radical (—C═O) or a hydroxyl radical (—OH). Particular examples of these components include alcohols, aldehydes, C₁-C₅ hydrocarbons, furans, and levoglucosans. The pyrolysis vapors or torrefaction vapors may also include relatively minor amounts of H₂ and CO. Exemplary the pyrolysis vapors or torrefaction vapors may therefore comprise, comprise substantially all, or consist of, any of these general and more specific components.

The “carbonaceous feed conversion zone” refers to a zone within the auger reactor that is exterior with respect to central shaft(s) of one or more augers of this reactor and interior with respect to a surrounding inner sleeve. In general, flights of the auger(s) extend into this zone, and this zone may be, or may include, an annular space. The “carbonaceous feed conversion zone,” or, in particular embodiments, “conversion annulus,” is a zone in which devolatilization of the carbonaceous feed in the auger reactor occurs.

The term “syngas,” or alternatively “synthesis gas,” for example as used in the more specific terms “syngas product,” “solids-depleted syngas product,” or “purified syngas product,” refers to gasification or partial oxidation vapors comprising H₂ and CO. A “syngas product,” is a particular gaseous product that is obtained from the auger reactor being operated for gasification or partial oxidation, as a thermal treatment of the carbonaceous feed (e.g., biomass). A “solids-depleted syngas product,” is a solids-depleted gaseous product that is obtained from the auger reactor being operated for gasification or partial oxidation, following a gas/solid separation, for example that removes at least some solid particulates entrained in a syngas product directly exiting the auger reactor. The solids-depleted syngas product may be, more particularly, a “solids-depleted gasification product” or a “solids-depleted partial oxidation product” in cases of the auger reactor being operated for gasification or partial oxidation, respectively.

A “purified syngas product,” refers to a gaseous product of an auger reactor (e.g., pyrolysis vapors, torrefaction vapors, or syngas product), optionally having been subjected to a gas/solid separation (e.g., to obtain solids-depleted pyrolysis vapors, solids-depleted torrefaction vapors, or a solids-depleted syngas product), but in any case obtained from a secondary thermal treatment (e.g., POX) as described herein. The secondary thermal treatment may optionally utilize an oxygen-containing secondary reactor feed to a secondary thermal treatment reactor or vessel (e.g., POX reactor). The secondary treatment vessel may generally operate at temperatures as described herein, and/or the purified syngas product, provided from the secondary thermal treatment, may have a combined concentration of H₂ and CO as described herein.

A “syngas product,” “solids-depleted syngas product,” “purified syngas product,” or other syngas that is obtained downstream of the carbonaceous feed (e.g., biomass) thermal treatment, generally comprises both H₂ and CO, with these components being present in various amounts (concentrations), and preferably in a combined amount of greater than about 25 mol-% (e.g., from about 25 mol-% to about 95 mol-%), greater than about 50 mol-% (e.g., from about 50 mol-% to about 90 mol-%), or greater than about 65 mol-% (e.g., from about 65 mol-% to about 85 mol-%). Independently of, or in combination with, the representative amounts (concentrations) of H₂ and CO above, a syngas (e.g., “syngas product,” “solids-depleted syngas product,” or “purified syngas product”), may comprise CO₂, for example in an amount of at least about 2 mol-% (e.g., from about 2 mol-% to about 30 mol-%), at least about 5 mol-% (e.g., from about 5 mol-% to about 25 mol-%), or at least about 10 mol-% (e.g., from about 10 mol-% to about 20 mol-%). Independently of, or in combination with, the representative amounts (concentrations) of H₂, CO, and CO₂ above, a syngas may comprise CH₄, for example in an amount of at least about 0.5 mol-% (e.g., from about 0.5 mol-% to about 15 mol-%), at least about 1 mol-% (e.g., from about 1 mol-% to about 10 mol-%), or at least about 2 mol-% (e.g., from about 2 mol-% to about 8 mol-%). Together with any water vapor (H₂O), these non-condensable gases H₂, CO, CO₂, and CH₄ may account for substantially all of the composition of a syngas. That is, these non-condensable gases and any water may be present in a syngas in a combined amount of at least about 90 mol-%, at least about 95 mol-%, or even at least about 99 mol-%.

As noted above, a “purified syngas product” may generally comprise H₂ and CO in a combined amount or concentration that is greater than that of the gaseous product (e.g., pyrolysis vapors, torrefaction vapors, or syngas product), and optionally the solids-depleted gaseous product (e.g., solids-depleted pyrolysis vapors, solids-depleted torrefaction vapors, or solids-depleted syngas product) from which the purified syngas product is obtained (e.g., following a secondary thermal treatment, such as POX, optionally in combination with an upstream gas/solids separation, performed on the gaseous product or optionally on the solids-depleted gaseous product).

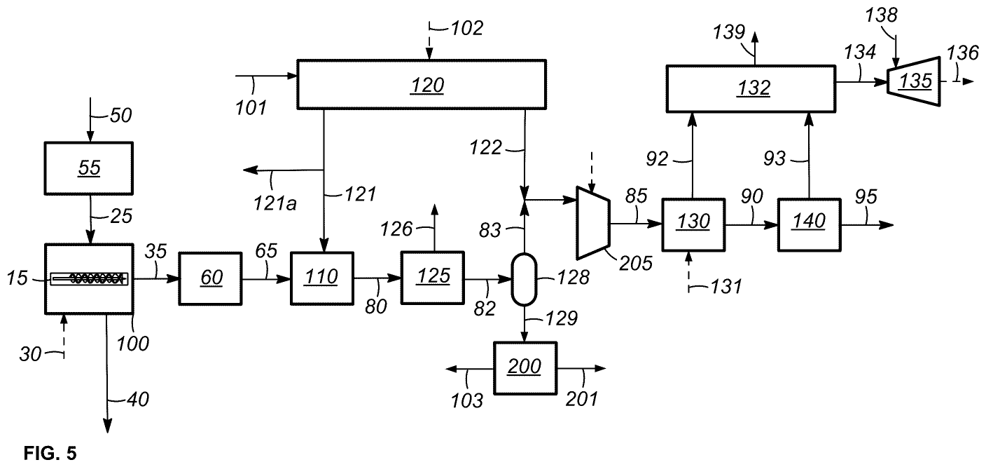

With respect to any such combined amounts (concentrations) of H₂ and CO described above, the H₂:CO molar ratio of the syngas (e.g., “syngas product,” “solids-depleted syngas product,” or “purified syngas product”) may be suitable for use in downstream conversion operations or separation operations), such as (i) the conversion to a renewable syngas conversion product comprising methanol via a catalytic methanol synthesis reaction, such as performed in a methanol synthesis operation or stage, for example according to the particular embodiment illustrated in FIG. 5, (ii) the conversion to a renewable syngas conversion product comprising higher molecular weight hydrocarbons and/or alcohols of varying carbon numbers via Fischer-Tropsch conversion, (iii) the conversion to a renewable syngas conversion product comprising renewable natural gas (RNG) via catalytic methanation that increases the methane content in a resulting RNG stream, or (iv) the separation of a renewable syngas separation product comprising purified hydrogen. A syngas (e.g., “syngas product,” “solids-depleted syngas product,” or “purified syngas product”) that has not been subjected to a water-gas shift (WGS) reaction, may have an H₂:CO molar ratio from about 0.5 to about 3.5, from about 1.0 to about 3.0, or from about 1.5 to about 2.5. In some cases, a WGS operation can be used to achieve a favorable (e.g., higher) H₂:CO molar ratio, and/or a favorable (e.g., higher) H₂ concentration, for these or other downstream syngas conversion and separation operations. For example, a WGS operation may be performed downstream of the auger-based thermal treatment, or secondary thermal treatment (e.g., POX) and upstream of a conversion or separation operation as described above.

### Representative Auger-Based Processes

Representative embodiments of the invention are directed to an auger-based process for thermal treatment of a carbonaceous feed (e.g., biomass, such as that present in MSW; waste plastics, waste rubber, etc.). The process comprises: in an auger reactor, conveying the carbonaceous feed with an auger conveyor from an upstream (e.g., a first) axial position to a downstream (e.g., a second) axial position under thermal treatment conditions sufficient to volatilize at least a portion of the carbonaceous feed into a (e.g., raw, particulate-containing) gaseous product (e.g., pyrolysis vapors, torrefaction vapors, or a syngas product, optionally together with char). Insofar as the thermal treatment may “volatilize” a portion of the carbonaceous feed (forming vapors of the gaseous product), this thermal treatment may likewise “devolatilize” another portion of the carbonaceous feed (remaining as a solid residue that manifests as char). The thermal treatment is therefore, in general, effective for both volatilization and devolatilization of portion(s) of the carbonaceous feed, and, depending on the environment (e.g., presence of oxidants and conditions), this thermal treatment may include, for example, pyrolysis, torrefaction, gasification, or partial oxidation. The auger conveyor may include at least one auger having a central shaft (with its length being in the axial direction, with respect to direction of conveyance of the biomass). The central shaft may correspond to an axis of rotation of the auger, with this axis being parallel to that, along which the carbonaceous feed is conveyed. The auger conveyer may further include radially-disposed flights, which are namely positioned or secured radially about the exterior of the central shaft, and which are preferably angled from the true radial direction with respect to the axial direction of this central shaft. That is, the flights may be may be pitched, relative to the axial direction, or otherwise may be perpendicular to this direction. The flights provide engagement with, and axial conveyance of (with possible comminution of), the carbonaceous feed. The central shaft houses a central heating element for generating all or at least a portion of heat for establishing the thermal treatment conditions, and in particular the operating temperature.

The upstream axial position, from which the biomass or other carbonaceous feed is conveyed, may be adjacent (e.g., may coincide axially with) a carbonaceous feed port (or feed inlet port). This may be configured for feeding or introducing the biomass to the auger reactor. The downstream axial position, to which the biomass or other carbonaceous feed (or to which the pyrolysis char, torrefied biomass, gasification char, or partial oxidation char, together with reaction/transformation products) is conveyed, may be adjacent (e.g., may coincide axially with) both a gaseous product port (or vapor outlet port) for withdrawing the gaseous product (e.g., pyrolysis vapors, torrefaction vapors, or syngas product) and a solids product port (or solids outlet port) for withdrawing char, possibly together with ash, or otherwise for withdrawing torrefied biomass. In some embodiments, biochar, comprising solid fixed carbon, may be withdrawn, and the char or biochar may be transferred from the solids product port via a discharge hopper. In the case of an auger-based torrefaction process, torrefied carbonaceous feed (e.g., torrefied biomass) may be withdrawn and transferred in this manner. The upstream axial position may be adjacent the carbonaceous feed port, and further adjacent a vapor feed port, as noted above, which may be configured for feeding or introducing a gaseous auger reactor feed. The gaseous auger reactor feed may be, for example, an inert, carrier gas-containing auger reactor feed, with representative carrier gases including N₂ and/or CO₂ in the case of pyrolysis or torrefaction. In the case of gasification or partial oxidation, the gaseous auger reactor feed may be, more particularly, an oxygen-containing auger reactor feed, as described herein.

The biomass or other carbonaceous feed may be transferred to the carbonaceous feed port via a feeder system utilizing a lock hopper or possibly equipment that not only transfers the carbonaceous feed, but also imparts a drying and/or forming (or shaping) function, as described above. The feeder system may be used, and particularly in the case of utilizing a lock hopper, for conveying carbonaceous feed in a vertical direction, whereas the auger conveyer preferably conveys solids in a horizontal direction, such that the upstream and downstream axial positions, for transfer of the carbonaceous feed and its volatilization/devolatilization products within the auger reactor, may be at substantially the same vertical positions. The carbonaceous feed port may be configured for accepting the biomass or biomass-containing solids (e.g., MSW), following its transfer that may occur optionally in conjunction with drying and/or forming (e.g., shredding, pelletization, or briquetting). It addition to providing transfer and possibly drying and/or forming functions, the feeder system may further be configured for pressurization of the biomass or other carbonaceous feed, for example to a pressure exceeding the operating pressure to facilitate solids transfer into the auger reactor.

The thermal treatment may be pyrolysis or torrefaction, such as performed in the absence or substantial absence of oxygen or other oxidant such as H₂O and/or CO₂, and such processes may be accompanied by the introduction of an inert, carrier gas-containing feed as a particular type of gaseous auger reactor feed. Alternatively, the thermal treatment may be gasification, or partial oxidation, such as performed in the presence of oxygen and/or other oxidants such as H₂O and/or CO₂, and such processes may be accompanied by the introduction of an oxygen-containing auger reactor feed, as a particular type of gaseous auger reactor feed. For example, oxygen may be introduced to the auger reactor, together with the carbonaceous feed and/or through one or more separate vapor feed ports, possibly adjacent a carbonaceous feed port and/or positioned at the upstream axial position, and/or possibly at one or more various, other axial positions. In this regard, to the extent that introduced oxygen may result in oxidation heat or combustion heat, or more generally reaction heat, that is internal to the process, in some embodiments representative processes may be carried out in the absence of any external combustion heat, referring to heat that is produced external to the reaction environment (e.g., to heat the auger reactor). In yet further advantageous embodiments, representative processes may be carried out in the absence of any external heat, referring to any heat that is produced external to the reaction environment (e.g., to heat the auger reactor), with the possible exception, in some embodiments, of electrical heat (e.g., provided from central heating element(s) or peripheral electric heater(s) as described herein). Some processes may be carried out with the sole input of heat to the reaction environment, excluding internal reaction heat, being through central heating element(s) housed within the central shaft(s) of the auger(s).

Representative thermal treatment conditions include an operating temperature of at least about 150° C., such as from about 150° C. to about 1050° C., or at least about 200° C., such as from about 200° C. to about 1000° C., or from about 450° C. to about 750° C., or from about 400° C. to about 650° C. In a number of applications, a nominal operating temperature of at least about 600° C. is preferred. Optionally in combination with these temperatures, thermal treatment conditions may include a solids residence time (e.g., residence time of biomass or other carbonaceous feed and its solid thermal degradation products, such as biochar) of from about 1 second to about 60 minutes, from about 3 seconds to about 45 minutes, from about 10 seconds to about 30 minutes, or from about 30 seconds to about 10 minutes. Optionally in combination with these temperatures and/or solids residence times, these thermal treatment conditions may include an elevated operating pressure, such as at least about 1 barg, for example from about 1 barg to about 100 barg, from about 5 barg to about 75 barg, from about 10 barg to about 50 barg, or from about 20 barg to about 40 barg. Optionally, an inner sleeve of the auger reactor, as described herein, does not isolate this operating pressure from a surrounding, ambient pressure.

The central heating element, which may provide some or all of the heat needed to maintain the operating temperate, may be, more particularly a central electric heating element. Examples of a central electric heating element include a central resistive heating element and a central inductive heating element. In yet more specific embodiments, the central electric heating element may be a central inductive heating element, configured for heating by an alternating magnetic field generated within the central shaft or generated externally with respect to the central shaft (such as generated from an electromagnet, e.g., coil, disposed (radially) externally to the central shaft and flights). For example, an electromagnet may be disposed about, or wound around an exterior surface of, an inner sleeve, a peripheral heater, an insulation layer, or a pressure shell, as described herein.

The at least one auger of the auger reactor may be disposed within an inner sleeve that surrounds the central shaft and radially-disposed flights. For example, the geometry of the inner sleeve may be configured to conform to the overall shape of the auger(s). This geometry may be cylindrical in the case of a single auger, or, in the case of two augers, it may be rectangular prismatic or may, as illustrated in FIG. 3, have a cross-section in the form of two intersecting, partial circular sections. The inner sleeve in combination with the central shaft(s) of the auger(s), or more specifically an interior surface of the inner sleeve and exterior surface(s) of the central shaft(s) may define, or enclose, a reactor volume or carbonaceous feed conversion zone, or conversion annulus having an annular space. In the case of a twin-auger system including two augers, these may have respective, first and second sets of flights, whereas additional augers may likewise have additional sets of flights (e.g., third and/or fourth augers may have respective, third and/or fourth sets of flights). Individual, first flights of the first set of flights may be positioned axially between individual, second flights of the second set of flights, such as in the case of the first and second sets of flights being interdigitated. Portions of individual first flights, of the first set of flights, may radially overlap portions of individual second flights, of the second set of flights. In this regard, FIGS. 2A and 2B show an auger reactor having two augers with axially-inclined (axially-pitched) flights that are configured with particular axial and radial positioning, in addition to other components of this reactor, as described above. The auger reactor may comprise at least one peripheral heater, for example conforming to the inner sleeve. The peripheral heater may be disposed externally to the central shaft and flights, for example it may be disposed about, or conform to an exterior surface of, the inner sleeve, and may optionally be disposed within the interior of a surrounding insulation layer. The insulation layer may be disposed, in turn, within the interior of a surrounding pressure shell. Components of an auger reactor, from its interior to its exterior, may have, for example, the specific configuration illustrated in FIG. 3.

Representative processes may further comprise, whether the thermal treatment is pyrolysis, torrefaction, gasification, or partial oxidation, separating entrained solids (e.g., particulates) from the gaseous product (e.g., pyrolysis vapors, torrefaction vapors, or syngas product), such as by using a suitable gas/solid separator, for example cyclone(s) and/or filter(s), to provide a solids-depleted gaseous product (e.g., that may be essentially, or possibly completely, free of solids). According to particular embodiments in which the auger-based thermal treatment is pyrolysis or torrefaction, representative process may also comprise contacting the solids-depleted gaseous product, in this case solids-depleted pyrolysis vapors or solids-depleted torrefaction vapors, as the case may be, with an oxygen-containing secondary reactor feed (or feed to a secondary reactor, such as a partial oxidation reactor) to perform partial oxidation of the solids-depleted gaseous product and provide a purified gaseous product (e.g., purified syngas product). The purified syngas product may advantageously have a reduced concentration of tars and oils (or generally hydrocarbons and oxygenated hydrocarbons having molecular weights greater than that of methane), which may be present in the pyrolysis vapors, or solids-depleted pyrolysis vapors, or which may otherwise be present in the torrefaction vapors, or solids-depleted torrefaction vapors, at concentrations ranging from, for example, 1 wt-ppm to 3 wt-%. The contacting of the solids-depleted gaseous product with an oxygen-containing secondary reactor feed may be performed in a partial oxidation reactor. In some cases, a plasma field may be incorporated to provide all or a portion of the heat required for partial oxidation, or to compensate for endothermic reactions occurring in the partial oxidation reactor.

According to other embodiments in which the auger-based thermal treatment is pyrolysis, representative process may also comprise separating entrained solids from the gaseous product, to provide solids-depleted pyrolysis vapors, and such processes may further comprise feeding or introducing the solids-depleted pyrolysis vapors into a secondary thermal treatment vessel (reactor), operating at a temperature above about 850° C., to convert the solids-depleted pyrolysis vapors into a purified syngas product that comprises predominantly H₂ and CO (i.e., comprises these components in a combined amount of at least about 50 mol-%). The purified syngas product may have an increased concentration in syngas, or H₂ and CO in combination, relative to that of the solids-depleted pyrolysis vapors, as a result of converting tars and oils in the secondary thermal treatment vessel to additional syngas. According to other embodiments in which the auger-based thermal treatment is gasification, representative process may also comprise separating entrained solids from the syngas product (as the gaseous product of gasification), to provide solids-depleted gasification vapors (as the solids-depleted gaseous product of gasification), and such processes may further comprise feeding or introducing the solids-depleted gasification vapors into a secondary thermal treatment vessel (reactor), operating at a temperature above about 850° C., to convert the solids-depleted gasification vapors into a purified syngas product that comprises predominantly H₂ and CO (i.e., comprises these components in a combined amount of at least about 50 mol-%). The purified syngas product may have an increased concentration of syngas, or H₂ and CO in combination, relative to that of the solids-depleted gasification vapors, as a result of converting tars and oils in the secondary thermal treatment vessel to additional syngas.

### Auger Reactors and Associated Components

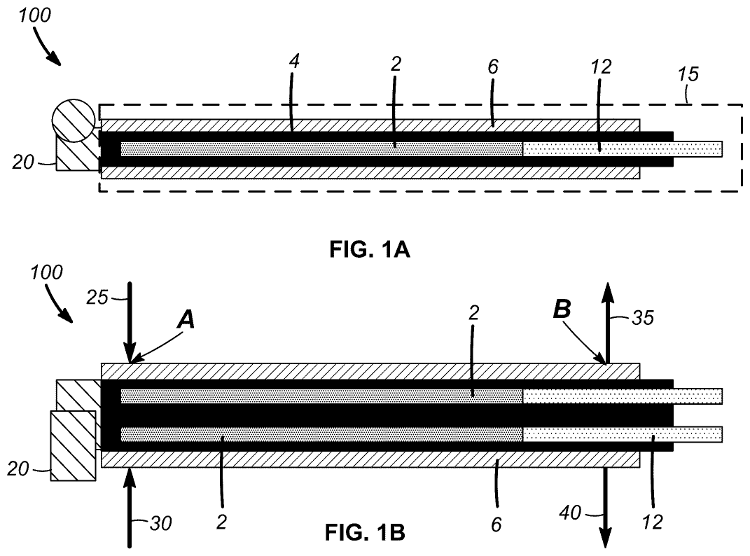

Some schematic details of a representative auger reactor 100 are provided in FIGS. 1A, 1B, 2A, and 2B. As shown, such auger reactor 100 may include at least one auger 15, having a central shaft 4 and flights 5, and, in the case of the particularly illustrated embodiment of a twin-auger system, may include a pair of such augers 15, as is apparent from the top view of FIGS. 1B and 2B. In the case of an auger reactor having a pair of augers, or possibly more augers, flights of any two adjacent augers may be overlapping, or interdigitated, as shown in FIG. 2B, in order to promote the reliable conversion of carbonaceous feeds that soften or melt. The central shaft(s) 4 of the auger(s) 15 may be hollow, and thereby used to house central heating element 2, such as a static bayonet-type electric heating assembly located inside each auger. The one or more auger(s) 15 may be enclosed in an inner sleeve 8 or auger sleeve, which does not necessarily support the load of pressurized operation (e.g., does not necessarily isolate, from ambient pressure, the operating pressure used in the thermal treatment conditions). The inner sleeve 8, together with central shaft(s) 4, define a space therebetween, namely carbonaceous feed conversion zone 6, which may also be referred to as a conversion annulus, insofar as at least a portion of carbonaceous feed conversion zone 6 is an annular space. In the case of a single auger 15, for example, the entire carbonaceous feed conversion zone 6 may be an annular space, whereas in the case of two augers, carbonaceous feed conversion zone 6 may include, in addition to an annular space, a central space in which flights of the two augers overlap, as shown in FIG. 2B.

One or more peripheral heaters 10 (e.g., electric heating elements) may be used, which may surround, for example by being affixed to, inner sleeve 8, such that heat can be transmitted easily through inner sleeve 8 and into carbonaceous feed conversion zone 6 where thermal treatment conditions, including an operating temperature and operating pressure as described herein are maintained. The heaters may, in turn, be surrounded by insulation layer 12 (e.g., in the form of a thick layer of insulating material), in order to prevent heat loss. The insulation layer may be enclosed in outer pressure shell 14 that isolates, from ambient pressure, the operating pressure used in the thermal treatment conditions. In this manner, outer pressure shell 14 may support the loads associated with pressurized operation, without being exposed, on its exterior surface, to any pressure or temperature higher than ambient. Whereas the interior surface of outer pressure shell 14 may be required to maintain an elevated pressure corresponding to an operating pressure as described herein, both this interior surface and the exterior surface of outer pressure shell 14 may be exposed to only relatively low, or even ambient, temperatures as described above.

At each end of each auger 15, the associated auger central shaft(s) 4 may have bearings that are insulated from operating temperatures as described herein, as well as dynamic seals (also functioning at ambient, or nearly ambient, temperature, such as less than 50° C.) that seal in, and contribute to maintaining the operating pressure of, carbonaceous feed conversion zone 6 within pressure shell 14, insulation layer 12, and peripheral heaters 10. These bearings and seals may be part of overall electrical drive gear 20, for rotating auger central shaft(s) and its/their associated flights 5. The carbonaceous feed conversion zone may extend from an upstream axial position A, for example proximate carbonaceous feed port 25 (from which carbonaceous feed is introduced to auger reactor 100) and/or proximate vapor feed port 30 (from which gaseous auger reactor feed is introduced to auger reactor 100), to downstream axial position B, for example proximate gaseous product port 35 (from which a gaseous product is withdrawn from auger reactor 100) and/or proximate solid product port 40 (from which a solid product is withdrawn from auger reactor).

The carbonaceous feed conversion zone is used for conveying and maintaining the carbonaceous feed and its thermal treatment products, such as a gaseous product as described herein, under thermal treatment conditions and for sufficient residence time to perform a desired transformation (e.g., via pyrolysis, gasification, or partial oxidation).

According to the embodiments of auger reactors shown in FIGS. 1A, 1B, 2A, and 2B, these may, more particularly, include an electrically-heated twin-auger with overlapping flights, for performing thermal treatment of carbonaceous feeds, including pyrolysis, torrefaction, gasification, or partial oxidation. For any given auger used in such thermal transformation, the devolatilization of the carbonaceous feed may occur within a heated carbonaceous feed conversion zone 6, at least a portion of which may include an annular space. An important advantage of using an auger reactor for thermal treatment as described herein is the ability to adjust torque and axial movement as needed to suit given feeds, for example those having a significant tendency to soften or melt (e.g., high-plastics containing MSW) and/or requiring significant force for conveyance through the conversion zone while the carbonaceous feed, or at least a portion thereof, is devolatilized. In the case of using twin augers as better illustrated in FIGS. 1B and 2B, the interaction of flights of two adjacent augers can prevent softened polymers from adhering to surfaces of their central shafts and flights, regardless of any particular degree of tack (stickiness) that develops during conveyance of these polymers. In addition, within hollow central shafts of each auger, static bayonet-type electric heating assemblies may be located in their respective hollow volumes for centralized heating. This may be supplemented with external heating from electric heating elements, such as peripheral heaters 10, surrounding inner sleeve 8 that encloses the twin augers, but not necessarily in a pressure-tight manner. The carbonaceous feed may therefore be heated from centralized heat transmission through auger central shafts 4, as well as external heat transmission through inner sleeve 8. Excessive heat loss may be prevented using insulation layer 12 external to peripheral heaters 10, with this insulation layer being enclosed by outer pressure shell 14 that is maintained at relatively low (e.g., ambient or near-ambient) temperature. In particular embodiments, outer pressure shell 14 supports the load of the operating pressure, according to representative ranges as described herein, associated with the particular heat treatment for which the auger reactor is used. At both ends of each auger central shaft 4, the bearings enabling shaft rotation may be insulated from the environment of carbonaceous feed conversion zone 6, and dynamic seals may be used to maintain gases, which evolve from the devolatilization, under high pressure within inner sleeve 8. Auger reactor 100 is capable of operating under thermal treatment conditions as described herein, for example at combined temperatures and pressures of up to 600° C. and up to 30 bar, respectively.

FIG. 3 illustrates a cross-sectional view of a twin-auger system, for example according to the embodiments shown in FIGS. 1A, 1B, 2A, and 2B, which, as described herein, can provide an effective solution for maximizing heat transfer while allowing the outer pressure shell (at least at its exterior surface) to remain at, or nearly at (e.g., within +/−5° C. of), ambient temperature. As likewise illustrated in FIGS. 2A and 2B, with further reference to FIG. 3, auger reactor 100 may adopt a multi-layer configuration with inner central heating element 2 (e.g., electric bayonet heater) being housed within central shaft 4 that may be constructed of heavy-walled pipe and have externally-welded flights 5. Other layers, as described herein, may be configured as carbonaceous feed conversion zone 6 (e.g., conversion annulus), inner sleeve or auger sleeve 8 providing an outer boundary of this zone, peripheral heater(s) 10, insulation layer 12, and outer pressure shell 14.

Accordingly, particular embodiments of the invention are directed to an auger reactor for thermal treatment of biomass or other carbonaceous feed. The auger reactor may comprise: an auger conveyer that includes at least one auger having a central shaft and radially-disposed flights for engagement with, and axial conveyance of, the biomass or other carbonaceous feed. The central shaft may house a central heating element. The auger reactor may further comprise an inner sleeve that surrounds the central shaft and radially-disposed flights. In some cases, the inner sleeve is not configured for isolating an elevated, operating pressure (e.g., in a range as noted above) from a surrounding, ambient pressure. The inner sleeve in combination with the central shaft(s) of the auger(s), or more specifically an interior surface of the inner sleeve and exterior surface(s) of the central shaft(s), may define, or enclose, a reactor volume or conversion annulus (carbonaceous feed conversion zone), having an annular space. The auger reactor of may further comprise at least one peripheral heater, which may conform to the inner sleeve, such as by having a curved shape, or by having sections with curved shapes, distributed on, or adjacent to, the exterior surface of the inner sleeve. Peripheral heater(s) may therefore be disposed externally to the central shaft and flights (e.g., disposed about, or conforming to an exterior surface of, the inner sleeve, the insulation layer, or a pressure shell). The auger reactor may further comprise an insulation layer disposed external to the at least one peripheral heater (and also external to the inner sleeve) and internal to an outer pressure shell, which may be configured for isolating an elevated, operating pressure.

From a materials standpoint, the auger reactor may be constructed of metals and/or metal alloys suitable for converting carbonaceous feeds under thermal treatment conditions, including temperatures and pressures within ranges as described herein, such as, in some embodiments, a nominal temperature of 600° C. In preferred embodiments with respect to the auger reactor, flexible screw conveyors (also known as helix conveyors, screw conveyors, spiral conveyors, and auger conveyors), such as available from Flexicon Corporation, offer efficiency and versatility, conveying bulk materials ranging from large pellets to sub-micron powders, including both free-flowing and non-free-flowing materials, with no separation of blended products.

### Feed Preparation and Transfer, Conveyance Through the Auger Reactor, and Product Removal

An auger reactor according to the invention may be exceptionally capable of accepting challenging carbonaceous feeds in an “as-received” form, such that shredding, pelletization, briquette formation, and other sizing and/or shaping steps, and optionally drying, may be avoided in particular embodiments. For example, although the moisture content of the carbonaceous feed will affect the amount of electrical energy needed to achieve full devolatilization, there may be no requirement, in certain embodiments, to dry this feed to any particular residual moisture level prior to conversion by pyrolysis or torrefaction, or by using an oxidative technique such as gasification or partial oxidation. The avoidance of drying the biomass or other carbonaceous feed, as a pretreatment step (e.g., upstream of the auger reactor) that might otherwise be considered necessary, may result in a significant improvement in process efficiency. According to embodiments in which the carbonaceous feed is not dried prior to conveying the biomass in the auger conveyor, the feed moisture level may vary, and heat input to the auger reactor may be adjusted based on, or in response to, this moisture level, such as by regulating this heat input through the central heating element and/or peripheral heating element(s), depending on the moisture level (e.g., a measured moisture level) of the carbonaceous feed. Optionally in combination with avoiding drying of the carbonaceous feed, other steps for pretreating the biomass or other carbonaceous feed that may be avoided include pelletization, briquette formation, or more generally the formation of larger, fused masses/shapes (e.g., upstream of the auger reactor or prior to conveying the carbonaceous feed with the auger conveyor).

It is therefore possible, in some embodiments, to eliminate/avoid all feed preparation and drying steps, which may, for example, generally be associated with other approaches to pyrolysis, torrefaction, gasification, or partial oxidation of biomass/MSW. Advantageously, drying and other pretreatment functions may be incorporated into the simple, robust, and powerful transport and handling characteristics of the auger reactor itself. The use of auger(s) provides for a high degree of flexibility, in terms of conveying carbonaceous feeds having a wide variety of physical forms and characteristics. That is, the auger(s) can effectively engage essentially a wide variety of solid material types, or even carbonaceous feeds that may be characterized as solid/liquid material mixtures, having varying dimensions (size and shape), distributions (uniformity), properties (e.g., density), etc. Such broadly-ranging materials/mixtures are compatible with forced conveyance by auger flights, through the carbonaceous feed conversion zone in which devolatilization occurs.

Further approaches for process simplification, in view of favorable heat transfer characteristics and other features of auger reactors, involve conveying biomass or other carbonaceous feed in the absence of recycled char or other solid heat carrier/heat transfer medium (e.g., a separate solid that is introduced with the carbonaceous feed for the purpose of transferring heat without being consumed by devolatilization or reactions occurring in the auger reactor). According to some embodiments, the auger reactor is not heated from an external combustive source (e.g., external to the reactor volume or conversion annulus), such as methane, or otherwise portions of the biomass feed and/or syngas product. The auger reactor may be heated solely from electrical as opposed to combustive heat (e.g., from resistance and/or inductive heating), and electricity used for providing this electric heat can be generated, in some embodiments, from renewable sources (e.g., in the case of wind-generated or solar-generated electricity). With the auger reactor being used for oxidative thermal treatment, such as in the case of gasification or partial oxidation, it may be possible to heat the auger reactor with some internal, but not external, reactor heat (e.g., heat, such as electrical heat, may be generated exclusively with the central heating element).

The use of auger(s) is compatible with many types of feeder systems, such as a lock hopper feeder system, a piston-based feeder system, or a screw-based feeder system having primarily or essentially a conveying function, as well as alternative types of feeder systems that may dry the carbonaceous feed and/or form it into desired shapes and/or impart desired properties (e.g., density). In some embodiments, therefore, prior to conveying the carbonaceous feed (e.g., biomass) within the auger reactor, this feed may be subjected to one or more drying and/or sizing pretreatment steps to better condition it for processing in the auger reactor. For example, depending on the specific carbonaceous feed, a forming step, such as a shredding, pelletization, or briquette-forming step, prior to its introduction into the auger reactor, may lead to further process simplification, with respect to eliminating relatively more complex mechanical conveying devices.

In the case of pelletization, briquette-forming, and other sizing pretreatment steps, these may serve to increase the density of carbonaceous feed, as well as form it into desired shapes, prior to introduction to the auger reactor. In the case of shredding, the biomass or other carbonaceous feed may be shredded (and possibly screened) to obtain shreds having a nominal average length dimension (e.g., as the longest dimension or screen size) from about 0.5 cm to about 25 cm, such as from about 1 cm to about 15 cm, or from about 2 cm to about 10 cm, prior to conveying the biomass with the auger conveyor. In the case of pelletization, the biomass or other carbonaceous feed may be formed into pellets (e.g., by extrusion through a die) having an average length dimension in the range from about 3 mm to about 75 mm, from about 5 mm to about 50 mm, or from about 10 mm to about 25 mm), and independently having an average diameter dimension in the range from about 0.3 mm to about 25 mm, from about 0.5 mm to about 15 mm, or from about 1 mm to about 5 mm). In the case of briquette forming, a piston-based biomass briquette-making device, or other suitable apparatus for forming briquettes from the carbonaceous feed, may be connected directly to the auger reactor (e.g., through the carbonaceous feed port), to eliminate the need for relatively more complex mechanical conveying devices. The biomass or other carbonaceous feed may be formed into solid masses having shapes and dimensions comparable to those of standard charcoal briquettes, and generally having average length, width, height, and/or diameter dimensions each independently in the range from about 10 mm to about 200 mm, from about 25 mm to about 100 mm, or from about 50 mm to about 75 mm).

Insofar as torrefaction is described as a thermal treatment process, it may also constitute a pretreatment that is performed to provide torrefied carbonaceous feed (e.g., torrefied biomass) for use in the auger reactor as described herein. Torrefied biomass, for example, represents a dried, at least partly devolatized, and densified form of biomass. Densification can also result from combining torrefaction with a palletization or briquette-forming step to provide densified, torrefied carbonaceous feed (e.g., densified, torrefied biomass) having improved characteristics (e.g., energy density) for use in auger-based processes described herein.

Whether or not any particular pretreatment step is used, the carbonaceous feed may be transferred to a port at an upstream end, or upstream axial position, of the auger reactor. For example, a lock hopper train utilizing an appropriate solids-dosing mechanism may transfer carbonaceous feed (e.g., biomass) in its bulk/raw state or optionally in its pretreated (e.g., shredded, pelleted, or briquetted) state, to a carbonaceous feed port. Depending on its type and composition, a certain weight percentage, such as from about 5 wt-% to about 45 wt-%, or from about 10 wt-% to about 20 wt-%, of the mass of the carbonaceous feed, on a dry basis, may be recovered as char (e.g., biochar) from a solids product port at a downstream end, or downstream axial position. A char lock hopper train may be used to recover the product char, following its separation, for example using a gas/solid separator such as a cyclone separator, from the gaseous product. Alternatively, or in combination, char may be recovered in this manner (e.g., as a separate portion) from a solids product port connected directly to the auger reactor. Char or other solids recovered from the auger reactor may subsequently be cooled and stabilized, allowing for handling and disposal under atmospheric conditions.

In the particular cases of pyrolysis and torrefaction, the auger reactor may provide a gaseous product comprising, respectively, pyrolysis vapors or torrefaction vapors (including volatile components of the carbonaceous feed), such as at an operating temperature and an operating pressure within ranges as described herein with respect to thermal treatment conditions. In the particular cases of gasification or partial oxidation, the auger reactor may provide a gaseous product comprising a syngas product, such as at these temperatures and/or pressures. Regardless of the particular thermal treatment, the gaseous product (e.g., hot volatile components, such as pyrolysis vapors, torrefaction vapors, or syngas product), will generally be maintained hot (e.g., at a temperature from about 400° C. to about 600° C.), for its introduction to a subsequent gas/solid separator (e.g., a cyclone separator), if used, to remove substantially all solids (e.g., char and ash particles). The separated solids may be recovered (e.g., as a char or biochar product) from such separator, in addition to the resulting solids-depleted gaseous product (e.g., solids-depleted pyrolysis vapors, solids-depleted torrefaction vapors, or solids-depleted syngas product), such as in the form of an essentially particle-free stream of hot volatile components. A stream of solids-depleted pyrolysis vapors (in the case of pyrolysis), solids-depleted torrefaction vapors (in the case of torrefaction), or solids-depleted syngas product (in the case of gasification or partial oxidation) may then be conveyed in a heated and insulated duct to a subsequent step of the process, such as a secondary thermal treatment (e.g., POX). Maintaining temperatures in excess of the condensation temperature (e.g., dew point) may be particularly significant, in view of the importance of preventing reactive species of the volatile components (oxygenates, radicals, heavy hydrocarbons, etc.) from condensing and/or reacting. That is, such species, and the solids-depleted gaseous product in general, should be maintained above its dewpoint temperature. In this regard, it has been determined that, in the case of pyrolysis and gasification of carbonaceous feeds (e.g., biomass), reactive species can effectively be prevented from forming tar and coke deposits if maintained at a temperature greater than about 400° C., or more preferably greater than about 500° C. Such species may then be partly or completely converted to yield additional syngas (H₂ and/or CO), in a purified syngas product obtained from a downstream POX stage of the process, or other secondary thermal treatment occurring at elevated temperatures (e.g., above about 800° C.) as described herein. This conversion may be performed by the injection of oxygen and the use of high operating temperatures characteristic of a POX reactor.

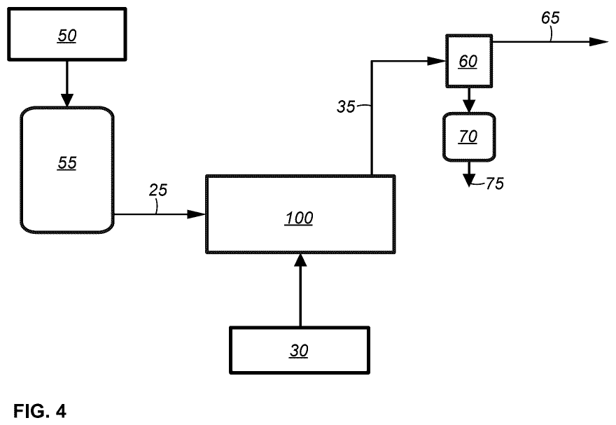

A representative auger reactor, as well as its components and auxiliary connections/systems is depicted in FIG. 4. These may include feeder system 55 (e.g., lock hopper feeder system, piston-based feeder system, or screw-based feeder system), connected to carbonaceous feed port 25 for transferring carbonaceous feed to auger reactor 100. In addition to transferring, feeder system 55 may, as described above, optionally impart drying and/or forming (e.g., shredding, pelletization, or briquette-forming) of the carbonaceous feed, which may be introduced to the feeder system as bulk/raw carbonaceous feed 50, for example bulk or raw biomass that may, in certain embodiments, be present in municipal solid waste (MSW). A lock hopper feeder system, piston-based feeder system, or screw-based feeder system, which generally do not impart drying and/or forming, may be further coupled with additional transfer equipment of a feedstock loading train, such as with a suitable conveyor belt. Auger reactor 100, receiving carbonaceous feed and conveying it, may further receive, as necessary for a given transformation, a gaseous auger reactor feed (e.g., an inert, carrier gas-containing auger reactor feed in the case of pyrolysis or torrefaction, or otherwise an oxygen-containing auger reactor feed in the case of gasification or partial oxidation) and/or heat (e.g., electrical heat). Such additional material and/or utility needs may be provided from auxiliary material and/or utility supply 30, which may more particularly include the vapor feed port for providing the gaseous auger feed (material supply) as shown in FIG. 1A.

As further shown in FIG. 4, auger reactor 100 may be further integrated, through gaseous product port 35, with solids removal/recovery systems for providing solids-depleted gaseous product 65, such as solids-depleted pyrolysis vapors (e.g., in the case of pyrolysis), solids-depleted torrefaction vapors (e.g., in the case of torrefaction), or solids-depleted syngas (e.g., in the case of gasification or partial oxidation). Exemplary solids removal/recovery systems include equipment for performing gas/solid separation, conveyance of the phase-separated materials, and optionally the treatment of separated solids, for example by purging, cooling, and/or stabilization. Separation may be performed using electrostatic forces, filtration, cyclones, or other suitable devices, and conveyance may be performed using conveyor belts, lock hoppers, flowing gas, or other suitable transport mechanisms. In one embodiment, a particular solids removal/recovery system may include a char recovery lock hopper train, in combination with an inert-purged char cooling and stabilization system. According to FIG. 4, pyrolysis vapors, torrefaction vapors, or a syngas product, received through gaseous product port 35, are provided to a solids removal/recovery system that includes gas/solid separator 60 (e.g., including one or more cyclones), together with solids removal system 70 (e.g., including a char lock hopper), to provide solids-depleted gaseous product 65 and separated solids 75. In the case of using one or more cyclones in gas/solid separator 60, such cyclone(s) and connected downstream gas transfer lines may operate at high temperatures (e.g., commensurate with the temperature of the pyrolysis vapors, torrefaction vapors, or syngas product as removed from auger reactor 100) for reasons noted above. For example, hot cyclone(s) for solid particle removal in gas/solid separator 60 may be connected at respective cyclone vapor outlet(s) to transfer pipe for solids-depleted gaseous product 65 that is heated and insulated to maintain high temperatures of this gas stream, for introduction to a subsequent operation, such as a secondary thermal treatment (e.g., POX). Representative wall temperatures of this transfer pipe, and gas temperatures within this pipe, which may be obtained from a combination of heating and insulation, are from about 200° C. to about 700° C., such as from about 250° C. to about 650° C., or from about 500° C. to about 600° C. In addition, this transfer pipe may have connections to a sampling train and/or flare stack.

Some pertinent characteristics of an auger reactor therefore include: (1) acceptance and reliable conversion/transformation of as-received carbonaceous feeds (e.g., biomass that may, in certain embodiments, be present in MSW), in many cases without requiring any or significant handling, preparation, drying, and/or other pretreatment; (2) efficient utilization of electrical energy for heating, with effective (e.g., complete or essentially complete) removal of volatile components from the carbonaceous feed at an electrical energy consumption rate, for example, from about 750 to about 2500 megajoules per metric ton of carbonaceous feed on a dry basis (MJ/t), such as from about 1000 to about 2000 MJ/t, or from about 1000 to about 1500 MJ/t; (3) production of chemically and thermally stable, separated solids, such as char that has been fully devolatilized, thereby rendering it suitable for use as a fuel or for cost-effective carbon sequestration; (4) conversion/transformation of a significant proportion (e.g., from about 65 wt-% to about 95 wt-%, from about 75 wt-% to about 95 wt-%, or from about 80 wt-% to about 90 wt-%) of the carbonaceous feed on a dry basis into a stream of a gaseous product (e.g., hot volatile components, such as pyrolysis vapors or torrefaction vapors, or a syngas product), which may be conveyed to downstream operations (e.g., POX) at elevated temperatures (e.g., at greater than about 350° C., or greater than about 500° C.), such as through a heated pipe, without developing operational problems related to tar or coke condensation/fouling.

Integration of Auger-Based Thermal Treatment with Methanol Production

Methanol is an essential molecule in the chemical industry, as a fundamental building block for producing a wide variety of end products, including clothing, textiles, construction materials, high-tech equipment, pharmaceutical products, and automotive components. Moreover, methanol is considered a clean-burning fuel, compared to some conventional fuels such as diesel or coal. The majority of the approximately 7.8 million tons of methanol produced annually in the United States (U.S.) is derived from fossil fuels, which renders methanol production a target industry for decarbonization. To that end, the use of an auger reactor, according to processes described herein, may provide for the economical and reliable conversion of biomass, such as that present in MSW, to cost-competitive low-carbon fuels and chemicals, specifically targeting methanol. In particular, the use of an auger reactor for pyrolysis may be integrated with a partial oxidation (POX) reactor to produce syngas.

In this regard, FIG. 5 provides a flow diagram of a preferred configuration of such integrated process, according to which oxygen and hydrogen feeds for gasification and methanation, respectively, may be generated from an electrolyzer, for example powered by renewable energy. According to a similar “front-end” auger-based pyrolysis system as shown in FIG. 4, it is likewise illustrated in the embodiment of FIG. 5 that bulk/raw carbonaceous feed 50 (e.g., MSW), may, optionally in conjunction with sizing pretreatment (e.g., for size reduction), become pressurized in feeder system 55, such as a lock hopper feeder system. Other possible pretreatment of the carbonaceous feed, such as drying and/or forming, may occur prior to the pretreated feed being admitted to auger reactor 100 through carbonaceous feed port 25 of this reactor, which is connected to feeder system 55. Within auger reactor 100, the carbonaceous feed is heated at least partly via indirect heat (e.g., using central and/or peripheral heating element(s)) to a temperature (e.g., nominally about 600° C.) and for a solids residence time (e.g., nominally about 1 second) as described herein as representative of suitable thermal treatment conditions. Such conditions are effective to provide separate phases of (i) the gaseous product (e.g., pyrolysis vapors) and (ii) char (e.g., solid fixed carbon) that is often accompanied by non-combustible ash, with these separate phases exiting auger reactor 100 through gaseous product port 35 and solids product port 40, respectively. A discharge hopper, such as a char lock hopper or other solids removal system 70 (FIG. 4), may be used for handling the char/fixed carbon that exits auger reactor 100 with ash, whereas the gaseous product may be routed from gaseous product port 35 through gas/solid separator 60, for example a cyclone separator. As further shown in FIG. 5, solids-depleted gaseous product 65, such as solid-depleted pyrolysis vapors, having been cleaned in gas/solid separator 60, proceeds to secondary thermal treatment reactor 110 (e.g., POX reactor), preferably without cooling to an extent that would result in detrimental solids deposition. For example, a representative temperature loss of solids-depleted gaseous product 65 between gas/solid separator 60 and secondary thermal treatment reactor 110 may be less than about 20° C., or less than about 10° C.

Within secondary thermal treatment reactor 110, which is additionally fed by oxygen-containing secondary reactor feed 121, solids-depleted gaseous product 65 is converted to purified syngas product 80 (e.g., POX effluent), by reaction with oxygen in oxygen-containing secondary reactor feed 121, optionally together with steam as an additional oxidant. According to the particular embodiment illustrated in FIG. 5, both oxygen-containing secondary reactor feed 121, as well as hydrogen feed 122, added downstream, may be obtained from electrolyzer 120 operating with fresh electrolyzer water 101 and electrolyzer electricity 102 as inputs, and with any surplus oxygen 121a being exported. Purified syngas product 80, having a reduced content of tars and oils relative to solids-depleted gaseous product 65 by virtue of undergoing oxidative reactions to convert these contaminants and yield additional syngas, may then undergo a number of further processing steps to provide conditioned syngas product 85 having a composition and other properties (e.g., pressure) that render it favorable for conversion in a downstream methanol synthesis block, or stage. Such further processing steps may include, for example, cooling, hydrogen addition, and compression. In this regard, as shown in FIG. 5, purified syngas product 80 may proceed through partial quench zone 125 for generating utility steam 126 that may be used, for example as a reactant in secondary thermal treatment reactor 110 (e.g., POX reactor) and/or for power generation (e.g., as a secondary use).

After exiting partial quench zone 125, cooled syngas product 82 can proceed through one or more cleanup steps, such as condensate removal in flash vessel 128, that provides condensate 129 to water treatment operation 200, which, in turn, outputs utility water, such as electrolyzer water 201 (that may be combined with fresh electrolyzer water 101) and general utility water 103. The resulting, dried syngas product 83 is combined with hydrogen, such as by being mixed with hydrogen feed 122 that is produced electrolytically, thereby adjusting the H₂:CO molar ratio to a favorable value (e.g., from about 1.5 to about 3.0). Compression, such as via compressor 205, either upstream or downstream of the combining with hydrogen (e.g., depending on the pressure at which this hydrogen is available), provides conditioned syngas product 85 that is suitable for use in a downstream methanol synthesis block to provide a final methanol product, such as purified methanol product 95. The methanol synthesis block, or stage, may include methanol synthesis reactor(s) 130, providing raw methanol product 90 that generally contains impurities such as fusel oil (including higher alcohols). Accordingly, this block, or stage, may further include methanol purification operation(s) 140, such as distillation and/or possibly others (e.g., flash separation and/or extraction). Either or both of (i) methanol synthesis reactor(s) 130 and (ii) methanol purification operation(s) 140 may generate respective hot byproducts 92, 93, and these may be routed to steam generator 132, for indirect heat transfer, optionally following combustion, to obtain additional utility steam 134 (e.g., beyond the amount generated as utility steam 126) and possibly utility electricity 136 if this steam, in turn, is fed to steam turbine 135. As can be appreciated in view of the embodiment illustrated in FIG. 5, additional inputs to the methanol synthesis block, or stage, may include methanol synthesis reactor heat (e.g., electrical heating) 131, and electricity-generating steam 138 to steam turbine 135. A further output may include flue gas 139, following heat transfer from, and optionally following combustion of, hot byproducts 92, 93.

The integrated process, whereby auger reactor-generated pyrolysis vapors are utilized for partial oxidation and subsequent methanol synthesis, may be a reliable alternative to the commercially available natural gas-based processes with carbon capture and sequestration (CCS), used for the production of methanol. Important advantages associated with this integration include a significant reduction in carbon intensity, energy consumption, and levelized cost of production, relative to current state-of-art methanol production routes from natural gas with CCS. These improvements reside in various features that can include process intensification, heat integration, incorporation of renewable power, and utilization of MSW or other bio-based (renewable) feedstocks. Further benefits that may be realized include (1) elimination of certain equipment that is associated with traditional natural gas to methanol plants having CCS capabilities, such as an air separation unit, water gas shift reactor(s), acid gas removal systems, CO₂ compressors, and CO₂ pipelines for transport to injection wells; (2) provision of an alternative for CO₂ capture and sequestration through the removal and land-filling of the solid fixed carbon byproduct (e.g., char) from the auger reactor; and (3) avoidance of plastics-related agglomeration/plugging issues encountered in conventional gasifier feed systems, with this advantage resulting from the capability of the auger reactor to fully volatilize a wide range of feeds such as MSW having a high plastics content.

Overall, aspects of the invention relate to the implementation of strategies for utilizing auger reactors, with centralized heating, for the thermal treatment of carbonaceous feeds. Such strategies may establish novel, economical, and reliable pathways for the utilization of MSW as a sustainable feedstock in particular, with the potential to divert millions of tons of this material from landfill disposal. Additionally, such auger-based thermal treatment processes can serve as a foundation for MSW thermochemical conversion to produce cost-competitive low-carbon fuels and chemicals. The commercial deployment of MSW-to-fuels/chemicals can be made economically more attractive in view of process-intensified characteristics described herein, optionally in conjunction with a significant incorporation of renewable power. Those skilled in the art, having knowledge of the present disclosure, will recognize that various changes can be made to these processes, and associated auger reactors, in attaining advantages described herein, as well as other advantages, without departing from the scope of the present disclosure. As such, it should be understood that the features of the disclosure are susceptible to modifications and/or substitutions, and the specific embodiments described herein are for illustrative purposes only, and not limiting of the invention as set forth in the appended claims.

1. An auger-based process for thermal treatment of a carbonaceous feed, the process comprising:
in an auger reactor, conveying the carbonaceous feed with an auger conveyor from an upstream axial position to a downstream axial position under thermal treatment conditions sufficient to volatilize at least a portion of the carbonaceous feed into a gaseous product;
wherein the auger conveyor includes at least one auger having a central shaft and radially-disposed flights for engagement with, and axial conveyance of, the carbonaceous feed, said central shaft housing a central heating element for generating all or at least a portion of heat for establishing said thermal treatment conditions.

2. The process of claim 1, wherein the thermal treatment is pyrolysis, torrefaction, gasification, or partial oxidation.

3. The process of claim 1, wherein said thermal treatment conditions include an operating temperature of at least about 200° C.

4. (canceled)

5. The process of claim 1, wherein the central heating element is a central electric heating element.

6. The process of claim 5, wherein the central electric heating element is a central resistive heating element or a central inductive heating element.

7. The process of claim 6, wherein the central electric heating element is a central inductive heating element, configured for heating by an alternating magnetic field generated within the central shaft or generated externally with respect to the central shaft.

8. The process of claim 1, wherein the at least one auger is disposed within an inner sleeve that surrounds the central shaft and radially-disposed flights.

9. (canceled)

10. The process of claim 1, wherein the auger conveyor includes two augers.

11-13. (canceled)

14. The process of claim 1, wherein said carbonaceous feed is transferred to said carbonaceous feed port via a lock hopper feeder system, a piston-based feeder system, or a screw-based feeder system.

15. The process of claim 1, wherein the thermal treatment is pyrolysis, wherein the process further comprises:
separating entrained solids from the gaseous product to provide solids-depleted pyrolysis vapors, and
contacting the solids-depleted pyrolysis vapors with an oxygen-containing secondary reactor feed to perform partial oxidation of said solids-depleted pyrolysis vapors and provide a purified syngas product.

16. The process of claim 15, wherein the contacting of the solids-depleted pyrolysis vapors with said oxygen-containing secondary reactor feed is performed in a partial oxidation reactor, and further wherein a plasma field is utilized to provide all or at least a portion of the heat required for partial oxidation.

17. The process of claim 15, wherein the gaseous product and solids-depleted pyrolysis vapors are maintained at a temperature of at least about 400° C. upstream of the partial oxidation reactor.

18. The process of claim 1, wherein the thermal treatment is pyrolysis, wherein the process further comprises:
separating entrained solids from the gaseous product to provide solids-depleted pyrolysis vapors, and
introducing the solids-depleted pyrolysis vapors into a secondary thermal treatment vessel operating at a temperature above about 850° C., to convert said solids-depleted pyrolysis vapors into a purified syngas product that comprises predominantly H₂ and CO.

19. The process of claim 18, wherein the purified syngas product has, relative to the solids-depleted pyrolysis vapors, an increased concentration of H₂ and CO in combination.

20. The process of claim 1, wherein the thermal treatment is gasification, wherein the process further comprises:
separating entrained solids from the gaseous product to provide solids-depleted gasification vapors, and
introducing the solids-depleted gasification vapors into a secondary thermal treatment vessel operating at a temperature above about 850° C., to convert said solids-depleted gasification vapors into a purified syngas product that comprises predominantly H₂ and CO.

21. The process of claim 20, wherein the purified syngas product has, relative to the solids-depleted gasification vapors, an increased concentration of H₂ and CO in combination.

22-26. (canceled)

27. The process of claim 1, wherein the carbonaceous feed is present in municipal solid waste (MSW).

28. An auger reactor, for thermal treatment of a carbonaceous feed, said auger reactor comprising:
an auger conveyer that includes at least one auger having a central shaft and radially-disposed flights for engagement with, and axial conveyance of, the carbonaceous feed, said central shaft housing a central heating element.

29. The auger reactor of claim 28, further comprising an inner sleeve that surrounds the central shaft and radially-disposed flights, wherein the inner sleeve is not configured for isolating an elevated, operating pressure from a surrounding, ambient pressure.

30. The auger reactor of claim 28, further comprising at least one peripheral heater, disposed externally to the central shaft and flights.

31. (canceled)
